(19) United States
(12) Patent Application Publication
(10) Pub. No.: US 2001/0040892 A1
(43) Pub. Date: Nov. 15, 2001

(54) METHOD FOR ACCESSING CUSTOMER SERVICE FROM TELEPHONY DEVICES AND INTERNET APPLICATIONS

(76) Inventor: STEVEN PETER SPENCER, LIVINGSTON, NJ (US)

Correspondence Address: ROBERT R JACKSON, FISH & NEAVE, 1251 AVENUE OF THE AMERICAS, 50TH FLOOR, NEW YORK, NY, 10020

(21) Appl. No.: 08/989,693

(22) Filed: Dec. 12, 1997

(51) Int. Cl. G06F 15/16; G06F 15/173

(52) U.S. Cl. 370/463; 709/203; 709/239; 709/249

(57) ABSTRACT

A method for accessing customer service from telephony devices and internet applications is provided in which the telephony devices and internet applications have interfaces specifically designated for accessing the customer service. Upon detection of a customer service request from these interfaces, the telephony devices and internet applications establish a connection to a customer service system either via a telecommunication network or web. Thereafter, the customer service system reads status information and executes a diagnostic script to detect and resolve problems that users are experiencing. The customer service system may utilize either an automated customer service server or a customer service agent in the process of addressing users' problems.

### BACKGROUND OF THE INVENTION

This invention relates to methods for accessing customer service from telephony devices and internet applications. More particularly, this invention relates to methods for providing a convenient and effective way the users of telephony devices and internet applications access a customer service agent and a customer service web server.

The internet commerce has gained great popularity recently. The arrangement in FIG. 1a illustrates a typical communication network in use today that allows service provider system 40 to provide internet retailing services to users at user devices 60 via internet service providers 50.

For example, web 30 enables user devices 60 to access various service providers 40 that range from retailers such as 1-800-Flowers™ and L.L. Bean™ to content providers such as ESPN™ and The New York Times™. User devices 60 are connected to internet service providers 50 such as AT&T World Net™ which functions as gateways to web 30.

In spite of its initial popularity, however, the internet commerce still has not reached its full potential because of various problems that arise due to unfamiliarity and complexity that users at user devices 60 face in using the internet. One difficulty typically associated with using internet is connection failures to internet service providers 50 or service providers 40. The users may resort to written manuals of internet service providers to find out what exactly their problems are, which, if at all helpful, may not necessarily provide resolution to their problems. Using the manuals can be a quite tedious task when finding the right page covering the subject matter of problem in the manuals poses quite a challenge. Generally, most users first look for a customer service telephone number from manuals and then call customer service representatives of internet service providers, which may turn out to be a tremendously time-consuming process due to the limited resources of the internet service providers.

Difficulties associated with using internet may also arise from technical updates or hardware failures at service provider system 40 or internet service providers 50 that the users at user devices 60 may not even be aware of. Other difficulties may be associated with the errors in system configurations at user devices 60.

Similar difficulties arise to the users of today's sophisticated and complex telephony devices containing high speed processors and displays. The users of telephony functions of user devices 60, for example, may have to experience a tedious and time-consuming process of locating the telephone numbers for appropriate customer services when they have problems. Again, the manufacturers or service providers of the telephony devices may not have adequate resources to promptly address needs of the telephony device users.

It is therefore an object of the present invention to provide users of telephony devices and internet applications with easy and effective methods for accessing customer service.

### SUMMARY OF THE INVENTION

This and other objects of the invention are accomplished in accordance with the principles of the present invention by providing methods for accessing a customer service system from a user's device that can be either a telephony device or internet application located within a communication network. The communication network may also include a service provider system, a public telephone network, a web and an internet service provider. The user's device contains an interface specifically designated for accessing the customer service system.

Upon detection of a customer service request from such interface, the user's device establishes a connection to a customer service system. The customer service system automatically reads status information from the user's device and subsequently executes a diagnostic script to detect a problem that the user is facing based on the status information. The resolution of such problem is routed back to the user device and, upon the approval of a user, implemented to solve the problem.

An internet script may be launched during the connection to the customer service system if the user device is an internet-capable device. Such connection may be established via the internet service provider and the web. Alternatively, the direct modem communication may be established using the public telephone network.

If the user device is a telephony device, a connection is established to a customer service agent located in the customer service system via a public telephone network. The custom service request is detected from an interface such as a hard physical button on the user device.

Further features of the invention, its nature and various advantages will be more apparent from the accompanying drawings and the following detailed description of the preferred embodiments.

### BRIEF DESCRIPTION OF THE DRAWINGS

FIG. 1a is a schematic diagram of a prior art network providing internet commerce.

FIG. 1b is a schematic diagram of a network infrastructure where the methods of accessing customer service in accordance with the present invention may be implemented.

FIGS. 2, 3 and 4 illustrate a flow chart of steps involved in the methods of accessing customer service in accordance with the present invention.

### DETAILED DESCRIPTION OF THE PREFERRED EMBODIMENTS

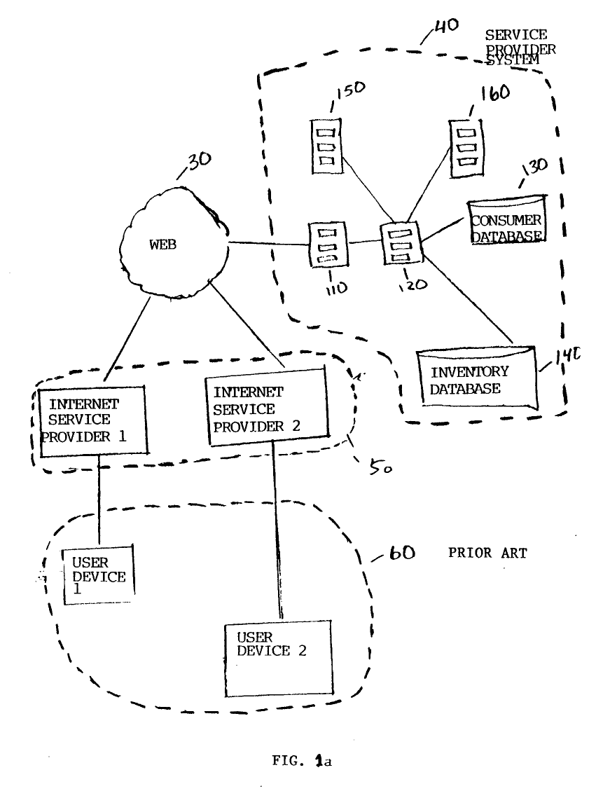

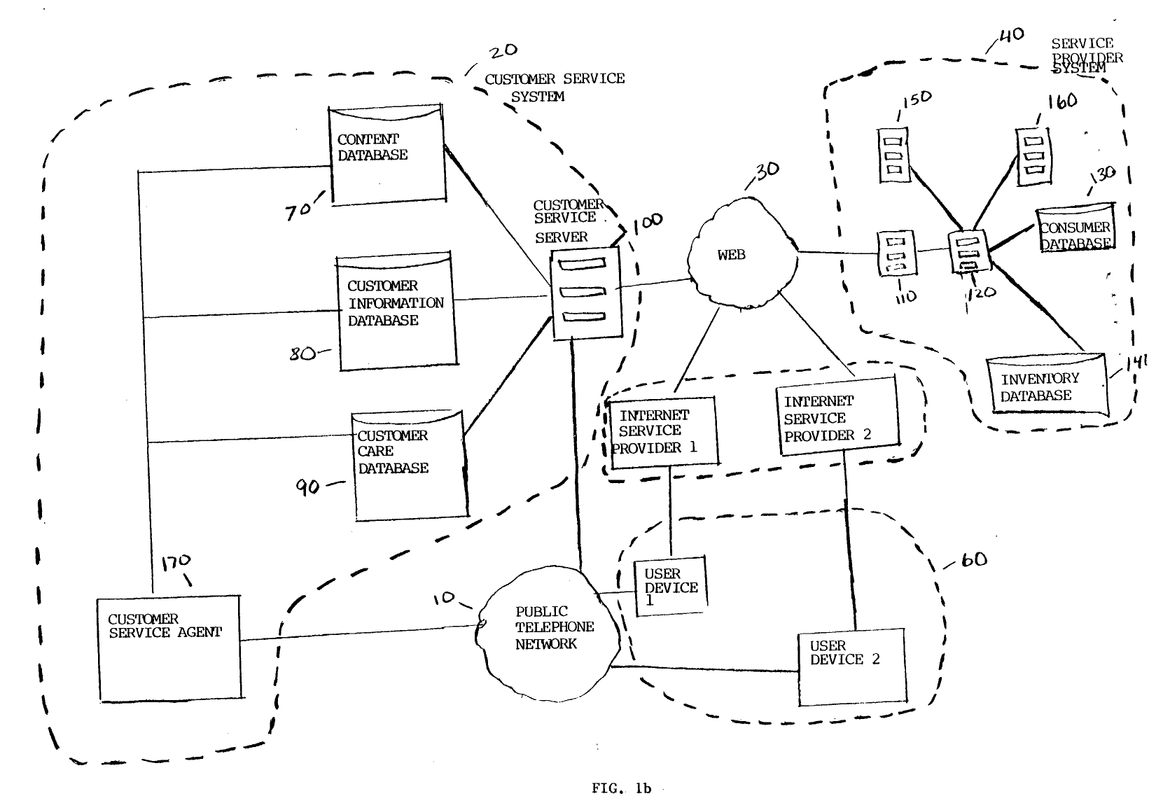

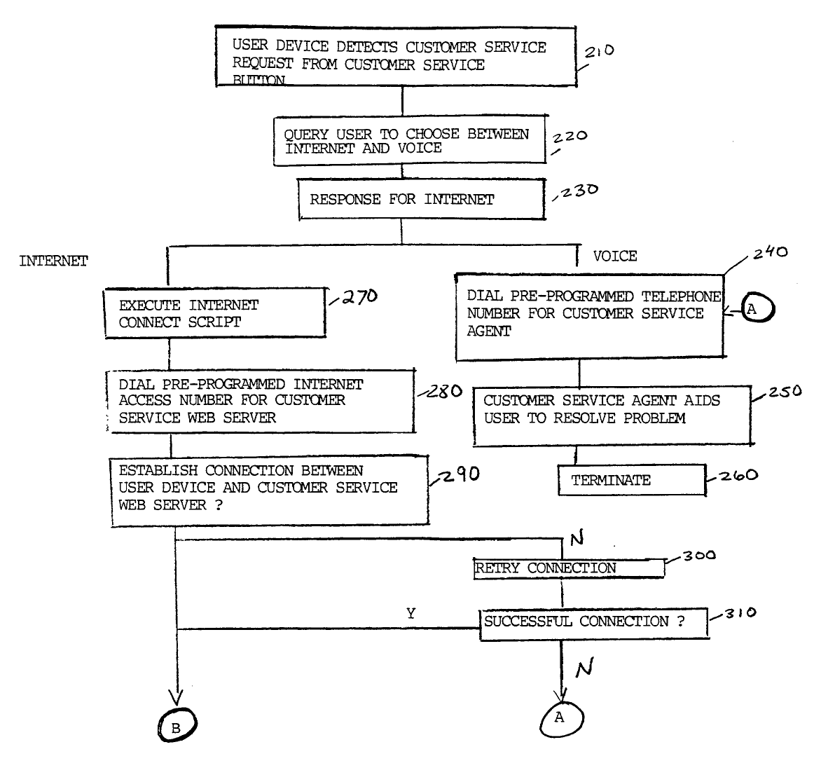

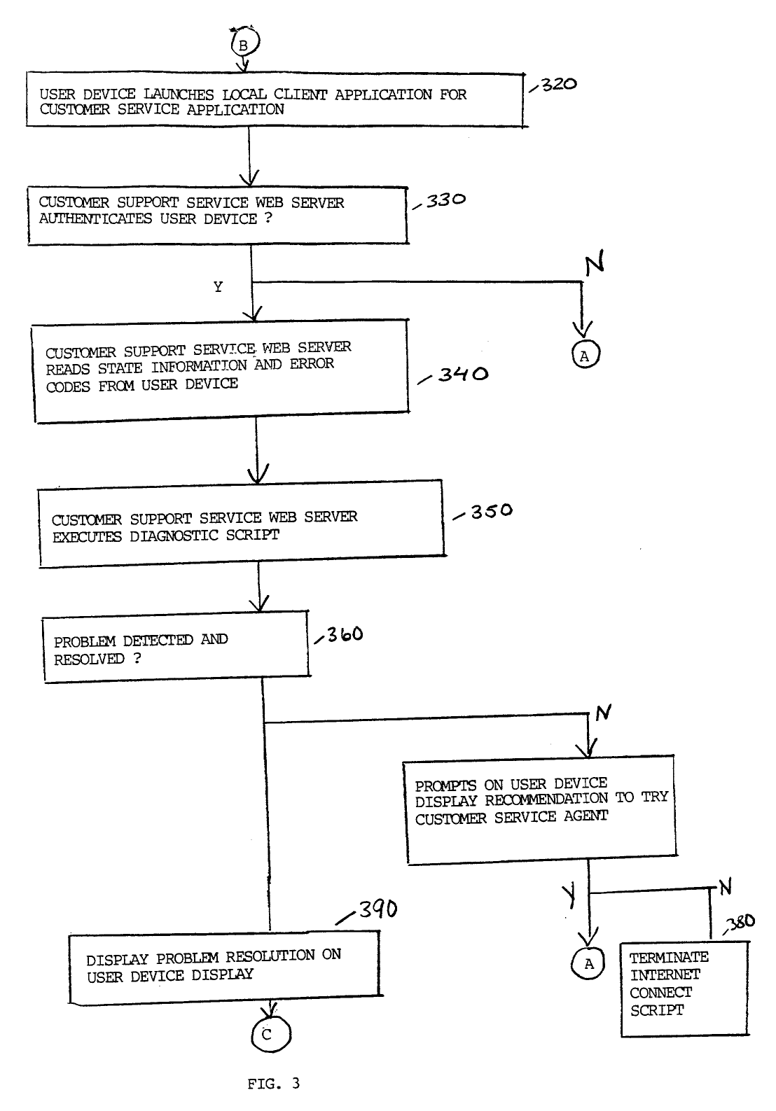

FIG. 1b illustrates communication network comprising public telephone network 10, customer service system 20, web 30, service provider system 40, internet service providers 50, and user devices 60.

User devices 60 have internet capabilities and web 30 enables the users of internet applications at user devices 60 to access customer service system 20. User devices 60 also have telephony capabilities where public telephone network 10 allows the users of telephony functions at user devices 60 to make connections to other telephony devices. As illustrated in FIG. 1b, the users at user devices 60 utilizes a direct modem connection to customer service system 20 via public telephone network 10. This network arrangement gives the users at user devices 60 a flexibility by providing an alternative way to access customer service system 20 or customer service agent 160, other than utilizing connections to internet service providers 50. For example, if the users at user devices 60 have problems in logging into service provider system 40, customer service system 20 or customer service agent 160 supports the users 60 in accessing and utilizing service provider system 40.

In order to provide effective customer service specific to each of the users at user devices 60, customer service system 20 maintains various databases containing user-specific information. More specifically, customer service system 20 may include content database 70, customer database 80, and customer care database 80, all of which are interconnected to each other to facilitate information exchange. Customer service server 100 and customer service agent use the information in these databases to support the users at user devices 60.

A portion of the user-specific information stored in customer information database 80 and customer care database 90 are input as a part of an initial registration process with customer service system. This may also be a part of the initial registration process with internet service providers 50. During the initial registration process, the users at user devices 60 are, for example, requested to input their local telephone numbers, passwords and account numbers of their internet service providers 50 or system configurations of user devices 60. Such information may be used by customer service system 20 to locate errors in user devices 60 and restore user devices 60 when user devices 60 are out of synchronization. Such information may also identify internet service providers 50 and post office protocol servers that handle electronic mails of the users at user devices 60.

Customer information database 80 is used to not only authenticate valid the users upon customer service request but also to register the users of user devices 60 each time the users access customer service system 20. During the access, customer information database creates data based on such registration profiles about the users' problems or needs. For example, a user may repeatedly forget or lose his password to log on to internet service providers 50. During the customer service transactions to retrieve, correct or reset the password, the nature of the transaction is recorded. If such problem recurs, the stored information about the user's last use allow to address the same problems. Customer care database 90 similarly maintains frequently asked questions by the users at user devices 60 so as to provide better technical supports in the future.

Content database 70, on the other hand, provides more general information such as advertisements or icons to be prompted on the screens of user devices 60, upon connection to customer service system 20. These advertisements may be on subscription bases providing alternative source of revenues to customer service system 20 and, therefore, allowing cost-effective customer service. Icons may provide the users at user devices 60 a convenient way to access various service provider systems 40 such as Schwap™ or Visa™ without having to type internet address. Content management database 70 may also provide upgrades of the software resident in user devices 60 or customize interfaces on user devices 60 such as icon configurations and colors.

Customer service server 100 and customer service agent 170 both have access to the above-mentioned databases to provide customer service to users at user devices. Customer service server 100 is primarily used to support internet applications at user devices 60 but may also provide similar services to telephony user devices 60 with displays. Customer service agent 170 is primarily used to respond to customer service request from telephony user devices 60. Customer service agent 170 also serves users of internet applications at user devices 60 when customer service server 100 is unable to correct users' problems.

Service provider system 40 typically includes the following components: Hyper Text Marked Language (“HTML”) server 110, application server 120, consumer database 130, inventory system database 140, transaction server 150 and content server 160. HTML server 110 for providing web formatted pages in hypertext marked-up large image format, is a gateway server connecting web 30 and application server 120. Application server 120 provides actual applications to run on HTML server 110. Consumer database 130 recognizes and authenticates the users based on a subscription criteria. Consumer database 130 also contains user specific data such as a users' demographic description, nature of the users' last purchase or users' address. Inventory database 140 keeps a track of merchandise stored in warehouses of service provider 40. Transaction server 150 supports commercial transactions, for example, by verifying credit card numbers and performing billing operations. Content server 160 provides substances such as pictures, texts and stock quotes to be placed on HTML screens.

User devices 60, which are capable of either or both of telephony functions and internet applications, contain interfaces that may be a physical service button on user devices 60 or an icon on a screen. Such interface is used to establish a communication link between user devices 60 and customer service server 100 via either web 30 or public telephone network 10. The communication link may, alternatively, be a wireless network. The direct communication link using telephone network 10 allows the users 60 to request help from customer service server 100 when a connection via internet service providers 50 fails.

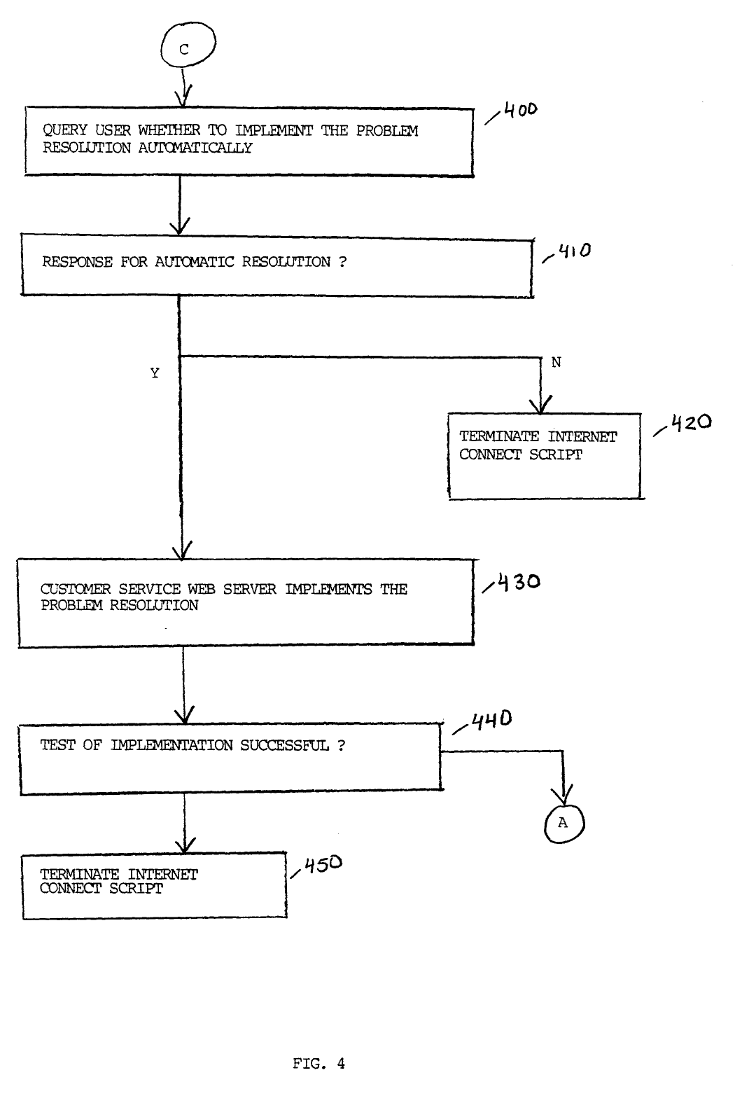

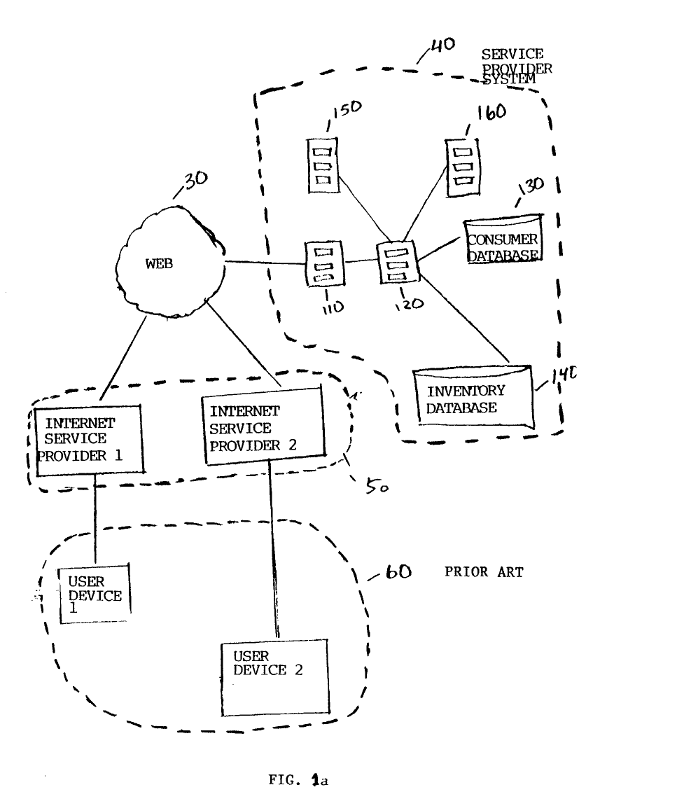

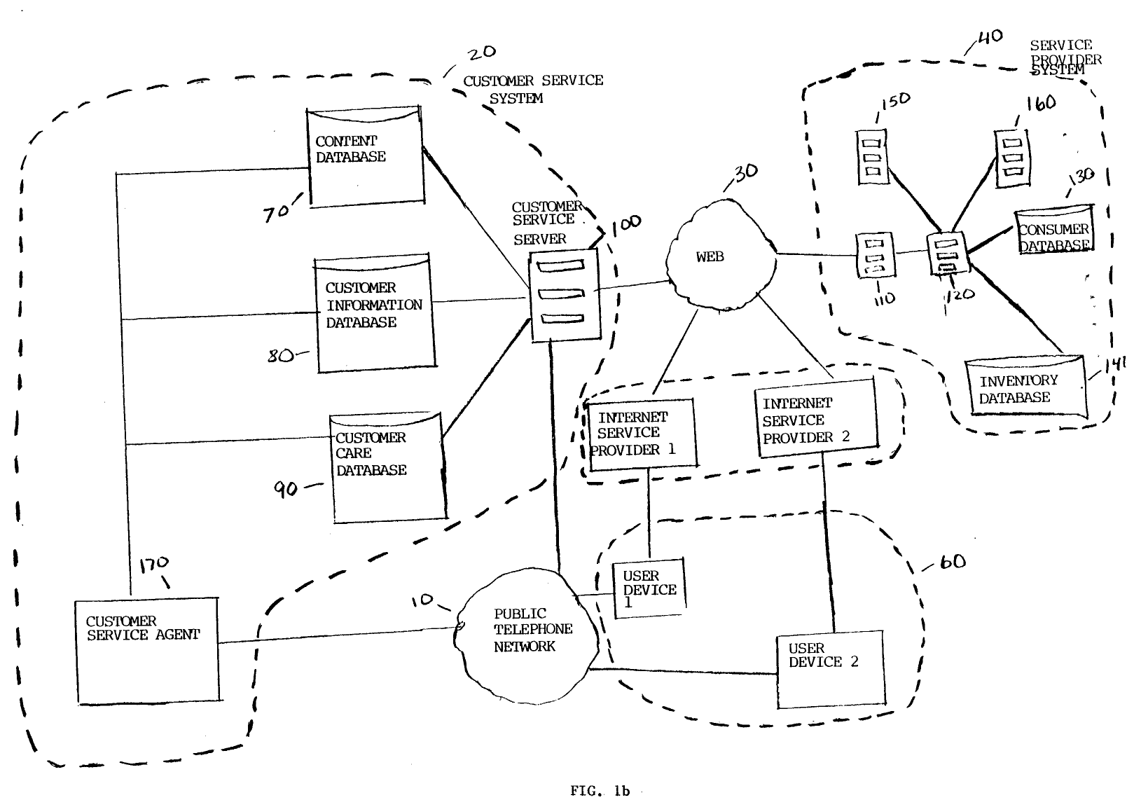

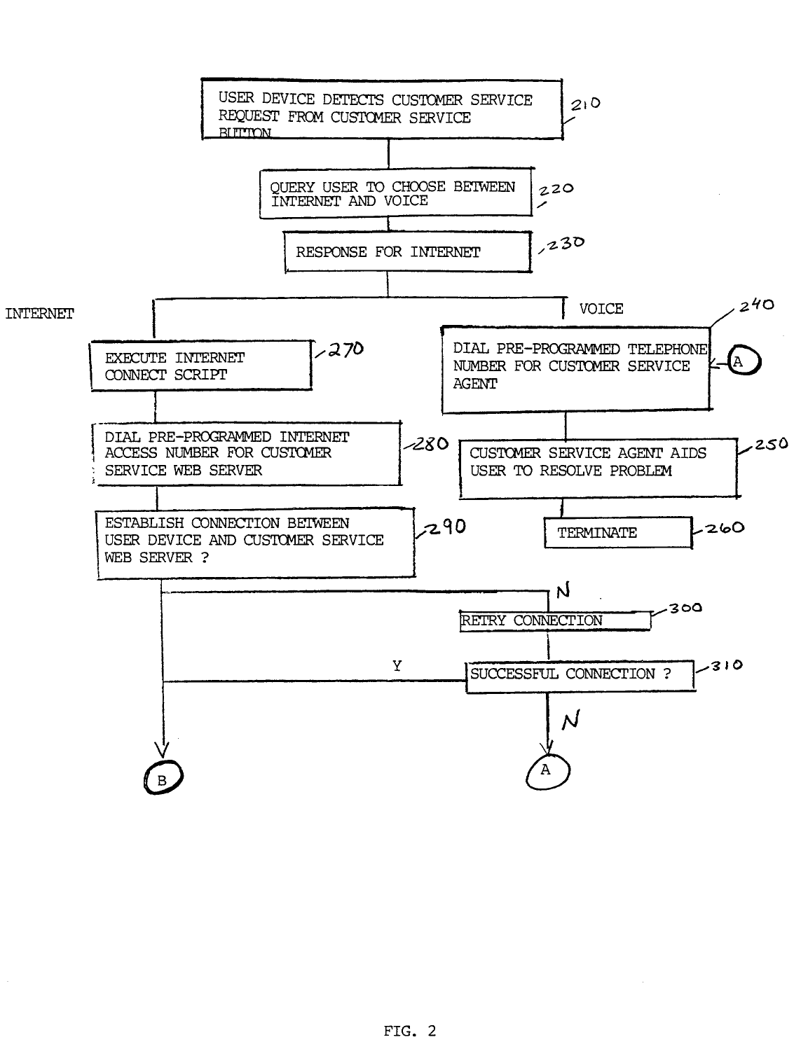

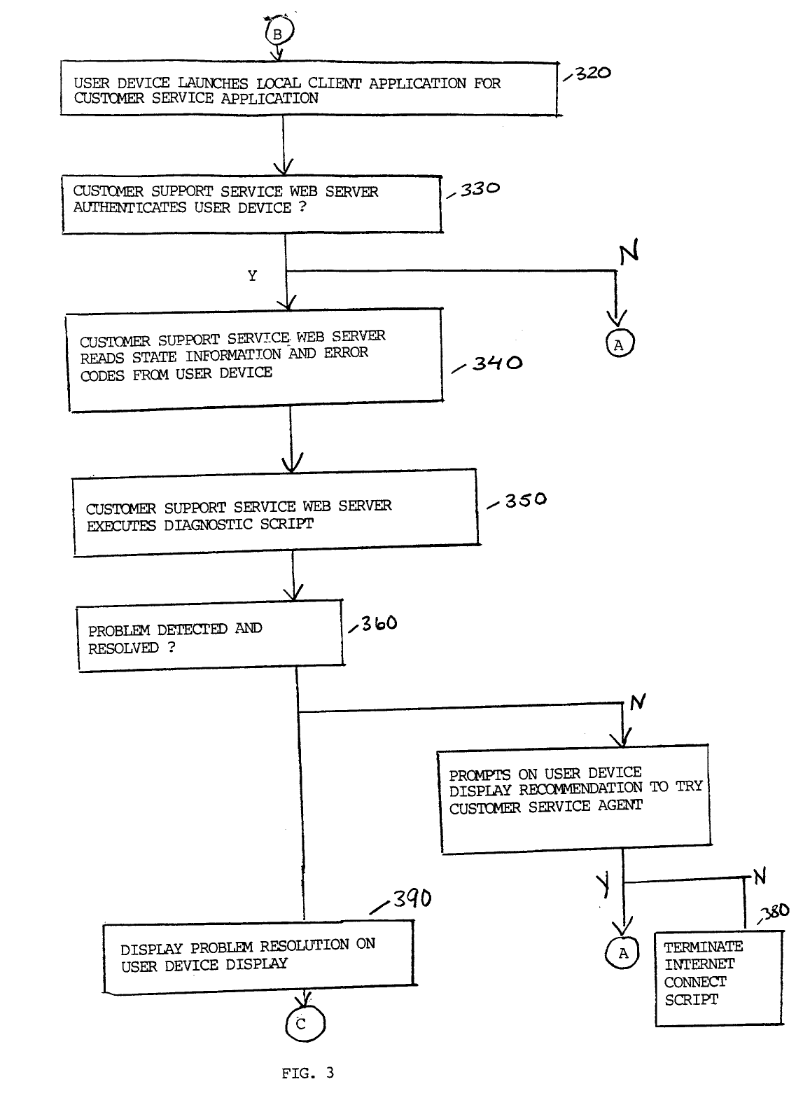

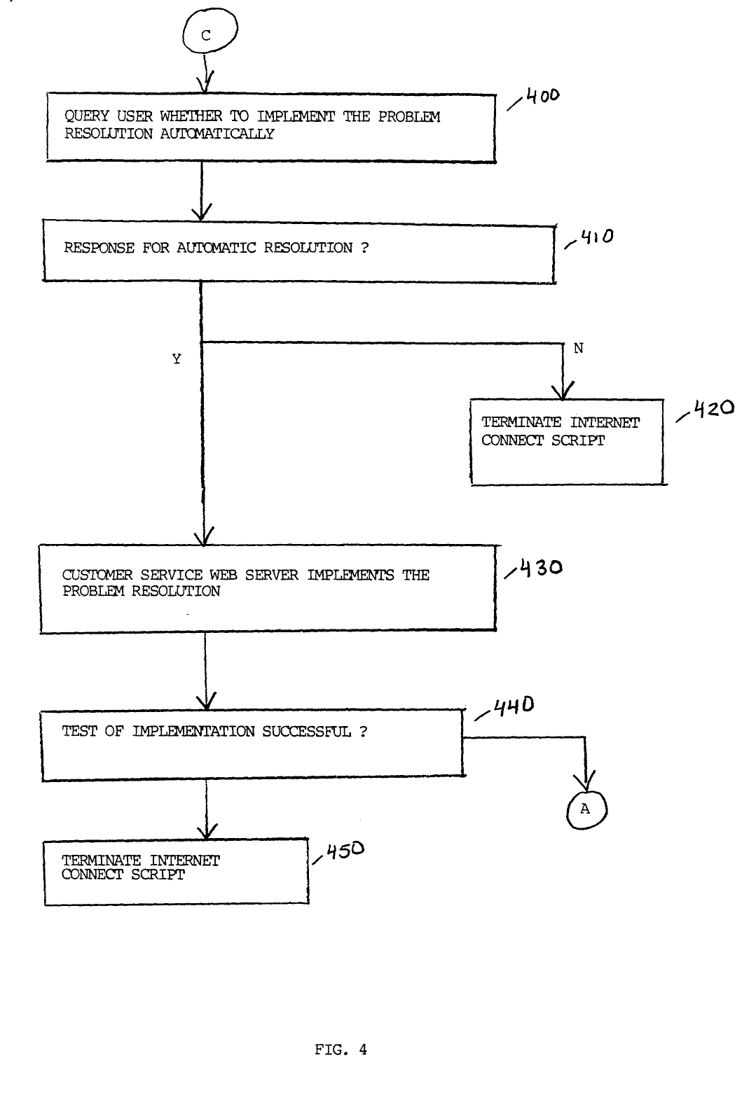

In FIG. 2, the steps in performing customer service in accordance with the present invention are illustrated. At step 210, user device 60 detects a users' request for customer service from customer service interfaces. For example, access to customer service 100 can be initiated by either pressing physical customer service buttons located on user devices' 60 or keys in user devices' 60 keyboards designated for customer service. The access may also be initiated depressing a preprogrammed icon on a screen. Consequently, a browser, browser-like or other appropriate client software application would be automatically launched between the users 60 and customer service server 100.

Any of the following situations would prompt the users at user devices 60 to request such service: user devices 60 are unable to establish connection to internet service providers 50; user devices 60 have invalid passwords; user devices 60 have trouble in receiving e-mails; users' accounts have been wrongly terminated; or internet settings in user devices 60 have defects.

At step 220, in response to the customer service request, user devices 60 query the users about the mode of customer service between internet or voice.

At step 230, user devices 60 determine whether the users has selected the internet mode. If it is determined that instead the voice mode is selected by the users, user devices 60 in step 240 dial a pre-programed telephone number to establish a connection to customer service agent 170 via public telephone network 10.

Once the connection is established, customer service agent 170 at step 250 diagnoses and resolves the users' problems by conversing with the users and analyzing information about the users' previous problems from customer information database 80 and customer care database 90. Subsequently, the connection is terminated at step 260.

If it is determined that the users have selected the internet mode, user devices 60 in step 270 execute an internet connect script. The internet connect script may be contained in storage devices such as read-only memory, hard disks or other devices connected to user devices 60.

At step 280, user devices 60 dial a pre-programed internet access number for customer service server 100. This number can be either an 800 number directly connecting to customer service server 100 or local numbers of internet service provider 50. In a latter case, an internet connection is made between user devices 60 and customer service server 100 via web 30.

At step 290, user devices 60 confirm the establishment of proper connection between customer service server 100 and user devices 60. If a proper connection is not confirmed, user devices 60 attempt redialing at step 300. If internet service providers 50 have been used in the first failed attempt to connect to customer service server 100, user devices 60 may switch and directly call customer service 100 server 100 using public telephone network 10.

In step 310, user devices 60 confirm a successful connection. If not, user devices 60 proceeds to step 240 and dial the telephone number for customer service agent 170.

If a successful connection is made between user devices 60 and customer service server 100 in either of steps 290 or 310, user devices 60 in step 320 launches local client applications to support customer service applications. The local client applications are, for example, browsers such as AT&T World Net™ browser.

Customer service server 100 authenticates user devices 60 at step 330 based on the registration information. The registration information is stored in customer information database 80 and used to determine if the users at user devices 60 have valid standing to use the customer service. If not, user devices 60 proceed to step 240 where the users at user devices 60 are requested, for example, to register with customer service system 20.

If it is determined that user devices 60 are valid, customer service server 100 in step 340 reads user devices' 60 state information and error codes from user devices 60. For example, an internet access configuration may be set up with errors causing connection failures between user devices 60 and internet service providers 50. This automatic reading of necessary data not only provides accurate data for customer service server 100 to detect problems but also free the users at user units 60 from manually inputting such data.

At step 350, customer service server 100 based on the appropriate state and error code information read from user devices 60 executes diagnostic script to identify problems that user devices 60 experience.

At step 360, customer service server 100 determines if user devices' 60 problem can be resolved. If customer service server 100 determines that the problem user devices 60 face is not resolvable with customer service server's 100 capacity, customer service server 100 recommends at step 370 that the users at user devices 60 to try customer service agent 170. If the users at user devices 60 respond positively to this recommendation, user devices 60 proceeds to step 240.

If it is determined that the problem can be resolved, customer service server 100 at step 390 displays resolution on user devices' 60 display. At step 400, the users at user devices 60 are queried about implementation of the resolution displayed. If user devices 60 respond negatively to implementation, customer service server 100 and user devices 60 in step 420 terminate the operations.

If user responds positively to the implementation recommendation, customer service server 100 and user devices 60 in step 430 implement the resolutions. For example, reconfiguration codes for network connection may be downloaded to user devices 60 and edited into resident programs in the user devices 60 to modify internet connection operations and resolve the problem.

In step 440, customer service server 100 and user devices 60 test, if possible, whether such implementation has addressed and resolved user's problems. If the problem persists, user devices 60 proceed to step 240 to obtain customer service agent's 170 assistance. If it is determined that implementation has been successful, customer service server 100 and user devices 60 in step 450 terminate internet connection script.

The foregoing is merely illustrative of the principles of this invention and various modifications can be made by those skilled in the art without departing from the scope and spirit of the invention.

What is claimed is:

1. A method for accessing a customer service from a user device, said user device having an interface for accessing said customer service, the method comprising the steps of:
detecting from said interface a request for accessing said customer service;
generating a signal responsive to said request; and
transmitting said signal to access said customer service.

2. The method defined in claim 1, further comprising the step of:
transmitting a state information of said user device.

3. The method defined in claim 1, further comprising the step of:
executing an internet connect script upon said request so as to transmit said signal via an Internet.

4. The method defined in claim 1, further comprising the step of:
receiving said customer service responsive to said transmitted signal.

5. The method defined in claim 4, wherein said customer service includes displayable information, further comprising the step of displaying said information on a display of said user device.

6. The method defined in claim 5, wherein said received customer service includes an executable program, further comprising the step of executing said executable program.

7. The method defined in claim 6, further comprising the step of testing a result of said executing step.

8. The method defined in claim 1, wherein said interface is a physical button located on said user device.

9. The method defined in claim 1, wherein said interface is an icon provided on a screen of said user device.

10. A method for providing a customer service from a customer service system, the method comprising the steps of:
receiving a signal containing a customer service request;
processing said customer service request to provide said customer service responsive to said customer service request;
generating a signal containing said customer service;
transmitting said signal from said customer service system to said user device;
receiving at said user device said customer service.

11. The method defined in claim 10, further comprising the step of authenticating said customer service request so as to provide said customer service only in response to said customer service request from a valid subscriber.

12. The method defined in claim 10, wherein in said processing step comprises the steps of:
routing said customer service request to a customer service agent; and
capturing said customer service from said customer service agent in response to said customer service request.

13. The method defined in claim 10, wherein in said processing step comprises the steps of:
executing a diagnostic script based on said customer service request; and
capturing said customer service generated from said diagnostic script.

14. The method defined in claim 10, wherein said customer service system comprises a web server.

15. A method for accessing customer service from a user device connected to a customer service system, said user device having an interface for accessing said customer service, the method comprising the steps of:
detecting at said user device a request for accessing said customer service from said interface;
generating at said user device a request signal responsive to said customer service request; and
transmitting said signal from said user device to said customer service system;
receiving at said customer service system said request signal;
processing at said customer service system said customer service request to provide said customer service responsive to said customer service request;
generating at said customer service system a response signal containing said customer service; and
transmitting said response signal from said customer service system to said user device.

16. The method defined in claim 10, wherein said generating step further comprises the steps of:
prompting at said user device a query to a user to select between a voice and automated customer service.

17. The method defined in claim 16, wherein said processing step further comprises the steps of:
routing at said customer service system said customer service request to a customer service agent if said voice customer service is selected; and
capturing at said customer service system said customer service generated from said customer service agent.

18. The method defined in claim 16, wherein said processing step further comprises the steps of:
executing at said customer service system a diagnostic script based on said customer service request if said automated customer service is selected; and
capturing at said customer service system said customer service generated from said diagnostic script.

19. The method defined in claim 18, further comprising the steps of:
routing at said customer service system said customer service request to a customer service agent if said execution step fails; and
capturing at said customer service system said customer service generated from said customer service agent.
